(19) United States
(12) Patent Application Publication
(10) Pub. No.: US 2022/0252506 A1
(43) Pub. Date: Aug. 11, 2022

(54) A Wirelessly Powered Frequency-Swept Spectroscopy Sensor

(71) Applicant: The Regents of the University of California, Oakland, CA (US)

(72) Inventors: Aydin Babakhani, Los Angeles, CA (US); Yuxiang Sun, Los Angeles, CA (US)

(73) Assignee: The Regents of the University of California, Oakland, CA (US)

(21) Appl. No.: 17/597,522

(22) PCT Filed: Jun. 30, 2020
(86) PCT No.: PCT/US20/40283

§ 371 Date: Jan. 10, 2022

Related U.S. Application Data
(60) Provisional application No. 62/872,850, filed on Jul. 11, 2019.

(51) Int. Cl. G01N 21/31; H01Q 1/22; H02J 50/00

(52) U.S. Cl. CPC G01N 21/31; H02J 50/001; H01Q 1/2283

(57) ABSTRACT

Systems and methods in accordance with embodiments of the invention implement wirelessly powered frequency-swept spectroscopy sensors. One embodiment includes a first antenna configured to receive an incoming signal; an energy-harvesting circuit configured to produce DC energy; a power management unit; an on-chip signal source configured to use the incoming signal as a locking signal; and a second antenna configured to transmit back a signal locked to the frequency of the incoming signal. In a further embodiment, the wirelessly powered frequency-swept spectroscopy sensor includes a third antenna, where the third antenna is on-chip.

### CROSS REFERENCE TO RELATED APPLICATIONS

The current application is a national stage of PCT Patent Application No. PCT/US2020/040283 entitled “A Wirelessly Powered Frequency-Swept Spectroscopy Sensor” to Babakhani et al., filed Jun. 30, 2020, which claims the benefit of U.S. Provisional Patent Application No. 62/872,850 entitled “Battery-Less Wirelessly Powered Frequency-Swept Spectroscopy Sensor” to Babakhani et al., filed Jul. 11, 2019, the disclosures of which are incorporated herein by reference in their entirety.

### FIELD OF THE INVENTION

The present invention generally relates to spectroscopy, and more specifically, to wirelessly-powered frequency-swept spectroscopy sensors.

### BACKGROUND

In recent years, low-power wireless sensor networks have attracted a great deal of attention in many applications such as health care and environment monitoring. One of the important technologies involved is absorption spectroscopy. Non-destructive non-contacting spectroscopy measurements can play an important role in drug and food safety characterization, harmful gas and oil leakage detection, and chemical and biological material analysis. However large and complicated spectroscopy systems can impede utilization in miniaturized sensor nodes.

### SUMMARY

Systems and methods in accordance with embodiments of the invention implement wirelessly powered frequency-swept spectroscopy sensors. One embodiment includes a first antenna configured to receive an incoming signal; an energy-harvesting circuit configured to produce DC energy; a power management unit; an on-chip signal source configured to use the incoming signal as a locking signal; and a second antenna configured to transmit back a signal locked to the frequency of the incoming signal.

In a further embodiment, the first antenna is an on-chip antenna.

In still a further embodiment, the first antenna is an off-chip antenna.

In a yet further embodiment, the second antenna is an on-chip antenna.

In a yet further embodiment again, the second antenna is an off-chip antenna.

In another embodiment again, the on-chip signal source is an on-chip oscillator.

In a yet further embodiment, the on-chip oscillator is a super-harmonic injection-locked oscillator.

In another embodiment again, the wirelessly powered spectroscopy sensor is configured to utilize frequency division duplexing.

In another embodiment still, the wirelessly powered spectroscopy sensor is fabricated using a silicon process.

In still a further embodiment, the wirelessly powered spectroscopy sensor is configured to use a duty cycle operation mode to provide a large instantaneous power in order to reduce an average power consumption of the sensor.

In another embodiment still, the wirelessly powered spectroscopy sensor further comprises a third antenna.

In another embodiment, the third antenna is an on-chip antenna.

In yet another embodiment, the wirelessly powered spectroscopy sensor is configured to radiate a signal through a material under test (MUT), where the signal is used to perform transmission spectroscopy of the MUT.

In still yet another embodiment again, a sensor chip includes: a first antenna configured to receive an incoming signal; an energy-harvesting circuit configured to produce DC energy; a power management unit; an on-chip signal source configured to use the incoming signal as a locking signal; a second antenna configured to transmit back a signal locked to the frequency of the incoming signal; and a third antenna configured to receive the locked signal.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 illustrates a wirelessly powered system for material spectroscopy measurement and a wirelessly-powered injection-locked spectrometer architecture in accordance with an embodiment of the invention.

FIG. 2A illustrates electro-magnetic (EM) simulating structure for near-field inductive coupling coils in accordance with an embodiment of the invention.

FIG. 2B illustrates EM simulating structure for far-field radiating dipole antennas in accordance with an embodiment of the invention.

FIG. 2C illustrates path loss comparison for the two configurations of near-field inductive coupling coils and far-field radiating dipole antennas in accordance with an embodiment of the invention.

FIG. 3A illustrates schematics of a receive (RX) antenna, matching circuit, and rectifier in accordance with an embodiment of the invention.

FIG. 3B illustrates an equivalent circuit model of the RX antenna, matching circuit, and rectifier schematic of FIG. 3A in accordance with an embodiment of the invention.

FIG. 4A illustrates simulated RX on-chip antenna radiation efficiency with silicon-on-insulator (SOI) CMOS substrate (0.1 S/m) and bulk CMOS process substrate (7 S/m) in accordance with an embodiment of the invention.

FIG. 4B illustrates simulated RX on-chip antenna radiation impedance with SOI CMOS substrate (0.1 S/m) and bulk CMOS process substrate (7 S/m) in accordance with an embodiment of the invention.

FIG. 5A illustrates simulated rectifier input resistance in accordance with an embodiment of the invention.

FIG. 5B illustrates simulated rectifier antenna source voltage swing to rectifier output DC voltage gain in accordance with an embodiment of the invention.

FIG. 6 is a circuit diagram of a power management unit in accordance with an embodiment of the invention.

FIG. 7 is a circuit diagram of a super-harmonic injection locked oscillator in accordance with an embodiment of the invention.

FIG. 8A illustrates transient result of voltage on storage cap, regulated voltage and enable signal in accordance with an embodiment of the invention.

FIG. 8B illustrates zoomed in region of active time of transient result of voltage of FIG. 8A in accordance with an embodiment of the invention.

FIG. 9A illustrates measured spectrum of injected-locked signal from 4 GHz to 5 GHz in accordance with an embodiment of the invention.

FIG. 9B illustrates comparison of measured spectrum of injected-locked signal with free-running signal in accordance with an embodiment of the invention.

FIG. 10 illustrates measured phase noise of an injection-locked signal compared to a free-running oscillator signal at 4.62 GHz in accordance with an embodiment of the invention.

FIG. 11 is a photograph of a chip with size of 3.8 mm by 0.65 mm in accordance with an embodiment of the invention.

FIG. 12 illustrates spectroscopy for liquid and solid MUT from 4.25 GHz to 4.75 GHz for different materials in accordance with an embodiment of the invention.

### DETAILED DESCRIPTION OF THE DRAWINGS

Turning now to the drawings, wirelessly-powered frequency-swept spectroscopy sensors in accordance with various embodiments of the invention are illustrated. Many embodiments provide a wirelessly powered frequency shift spectroscopy sensor microchip that can be utilized in a broad range of applications including (but not limited to) material characterization. For example, a spectroscopy sensor in accordance with several embodiments of the invention may be used in various medical implants that are capable of performing functions including (but not limited to) bleeding detection, detecting fluid in a kidney, detecting the amount of the fluid in any tissue, detecting cancerous tissue based on a change in the absorption of electromagnetic waves by the tissue, and/or detecting cancerous tissue based on a change in the dielectric condition of the tissue. Likewise, the spectroscopy sensor in accordance with several embodiments of the invention may be used in industrial monitoring (e.g., detecting corrosion, change in the dielectric, detecting cracks in industrial setting, in cement, in wellbores, among various other application) and/or consumer electronics (e.g., detecting fingerprints, identification of objects, touch sensors, smart phones, among various other applications).

In many embodiments, spectroscopy sensors can be implemented as millimeter-sized sensor nodes that can be distributed throughout an environment to provide ubiquitous sensing and processing. In a number of applications, changing batteries for each of the sensor nodes may not be practical; therefore, many embodiments use wireless power transfer. Among different energy-harvesting sources, near field magnetic coupling and far-field electromagnetic radiation may be utilized. The near field inductive coupling may have large power transfer efficiency in the near field distance. However, miniaturization of an on-chip receiving coil may cause efficiency to suffer due to a small coupling coefficient and quality factor of the receiving coil. In this way, the operating distance for a miniaturized receiving coil can be limited. Far-field power transfer utilizing a pair of transmitting and receiving antenna can achieve less path loss at far-field distances. However, conventional far-field RFID typically operates at low sub-giga Hertz frequencies, which may incorporate large off-chip antenna exceeding an area of 10 cm². Another drawback for conventional RFID can be that the reflected back signal may be at the same frequency as the incoming signal. This can pose a large interference directly from external transmitter (TX) to receiver (RX), which can make the detection of weak backscatter signal difficult.

In several embodiments, the spectroscopy sensor includes an efficient and sensitive wireless energy harvesting front-end with integration of an on-chip antenna and a wide locking range oscillator. In a number of embodiments, the spectroscopy sensor includes an efficient and sensitive wireless energy harvesting front-end with an off-chip antenna and a wide locking range oscillator. In many embodiments, wirelessly-powered mm-sized injection-locked oscillators can be utilized for material spectroscopy applications. In several embodiments, the spectroscopy sensor includes an efficient and sensitive wireless energy harvesting front-end with an antenna and a wide locking range signal source. In various embodiments, the antenna may receive electromagnetic energy from a continuous-wave source. In a number of embodiments, the continuous-wave source is in the X-band frequency. In certain embodiments, a super-harmonic injection-locking oscillator may lock to the frequency of the input and can produce a synchronized signal at half the frequency of the input. This new signal may then be radiated back using an on-chip or an off-chip dipole antenna, which may resolve the conventional self-interference issue in RFID sensors. In addition, the locking mechanism can improve phase noise of the on-chip oscillator to −93 dBc/Hz at 100 Hz offset. As can readily be appreciated, the specific value for phase noise can vary as appropriate to the requirements of specific applications in accordance with various embodiments of the invention. The large locking range of the transmitting signal can be beneficial for spectroscopy applications including (but not limited to) spectroscopy applications involving material detection and analysis.

Accordingly, many embodiments of the invention address the above-mentioned limitations by providing a wirelessly powered spectroscopy sensor that can include various combinations of any of the following components including (but not limited to) combinations with components in addition to the following components: an on-chip or off-chip antenna for receiving electromagnetic energy, energy harvesting circuits to produce DC energy, a power management unit, an injection-locked oscillator, and a second on-chip or off-chip antenna to transmit back a signal locked to the frequency of the incoming signal. Besides using far field radiation, many embodiments of the wirelessly powered spectrometer improve the operating distance by utilizing a low loss substrate available in an SOI process. The low loss (e.g., conductivity) of the substrate may improve the antenna efficiency. Moreover, a duty cycle operation mode can be used to provide a large instantaneous power while reducing the average power consumption of the chip. This mode may improve the operating distance of the chip in accordance with many embodiments. Certain embodiments of the implemented device have been successfully tested with a maximum power link distance of 8 cm, while achieving 22% locking range from 4 to 5 GHz and phase noise of −93 dBc/Hz at 100 Hz offset. In certain embodiments, the large locking range may be intended for spectroscopy application and material characterization from 4.25 GHz to 4.75 GHz. Note that the specific numbers for frequency range and phase noise distance can vary.

In several embodiments, the wirelessly powered frequency shift spectroscopy sensor microchip is implemented using a 180 nm CMOS process. In certain embodiments, an external TX wirelessly transfers power to the microchip, which may also be the injection signal to the on-chip antenna. In many embodiments, the far-field radiation power transferring configuration can achieve a power link distance of approximately 8 cm with a millimeter size on-chip coil for inductive coupling power transfer. As can readily be appreciated, the specific distance over which wireless power transfer can be achieved can vary. In several embodiments, the chip receives power and may turn on a super-harmonic injection-locked oscillator (Sup-IL Osc) in duty-cycle mode. In a number of embodiments, the oscillator may be locked and can transmit the signal back at half of the incident signal to an external RX. In several embodiments, the transmitted signal can be from 4 to 5 GHz. As can readily be appreciated, the specific frequency utilized for the transmitted signal is largely dependent upon the requirements of specific applications. In several embodiments, frequency division duplexing is utilized by the transmitter and receiver so that the transmitted back signal does not directly interfere with transmission from an external transmitter to the microchip's receiver, which can improve the receiver sensitivity and/or operation distance. A material-under test (MUT) can be placed in between the wirelessly-powered sensor chip and an external receiver. Due to the unique absorption spectrum for different materials, the transmitted back signal may be received as the spectroscopic response of the MUT.

While specific wirelessly powered frequency-swept spectroscopy sensors are described above, any of a variety of different configurations of a battery-less wirelessly powered frequency-swept spectroscopy can be utilized as appropriate to the requirements of specific applications in accordance with embodiments of the invention. Circuit implementations are disclosed further below.

### Spectroscopy Sensors

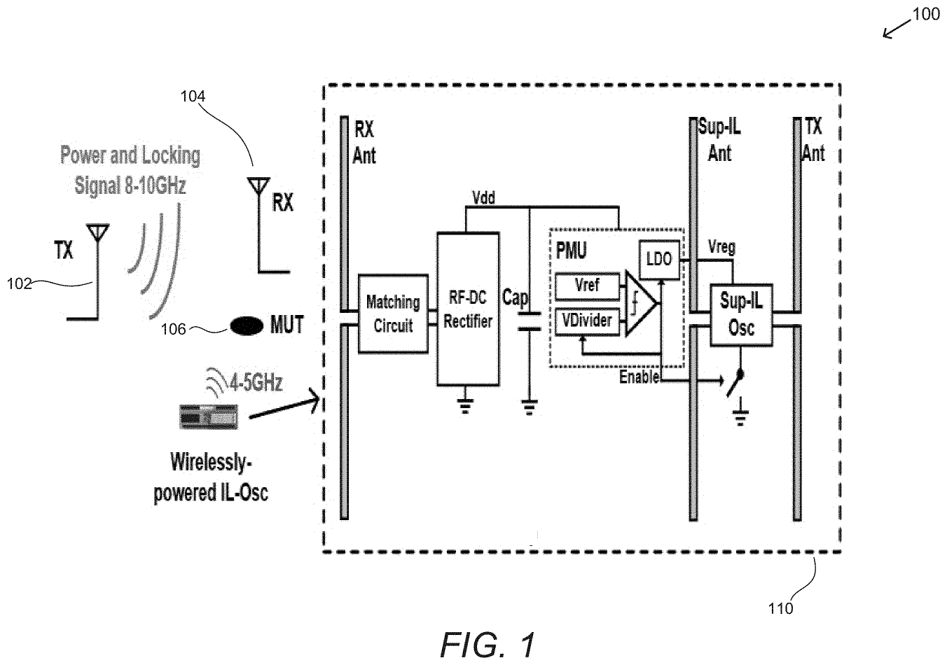

A block diagram of a wirelessly powered spectroscopy sensor system 100 in accordance with an embodiment of the invention is illustrated in FIG. 1. In the illustrated embodiment, an external transmitter source 102 transmits wireless power to the spectroscopy sensor 110 using a wireless power signal. In several embodiments, the external transmitter transmits wireless power using a signal in the frequency range of 8 to 10 GHz. As can readily be appreciated, the specific frequencies utilized to transmit wireless power are largely dependent upon the requirements of a given application. In several embodiments, the signal transmitted by the external transmitter source 102 can also be used as a locking signal for an on-chip oscillator within the spectroscopy sensor 110. In many embodiments, the spectroscopy sensor 110 can include an on-chip receive (RX) antenna 104. In several embodiments, the RX antenna 104 can be off-chip.

In certain embodiments, controlled by a power management unit (PMU), the sensor chip 110 may receive power and may turn on a super-harmonic injection-locked oscillator (Sup-IL Osc) in a duty-cycle mode. The Sup-IL Osc can be locked and may transmit a signal back to the external source 102 with a frequency of 4 to 5 GHz, which is half of the frequency of the incoming signal. As can readily be appreciated, the specific frequencies utilized to transmit back to the external source are largely dependent upon the requirements of a given application. In various embodiments, the sensor architecture may utilize a frequency division duplexing to minimize the interference caused by the external power source, improve the RX sensitivity, and increase the operating distance. The signal radiated by the chip can be passed through different materials and used to perform transmission spectroscopy of the material-under-test (MUT) 106.

In several embodiments, a link distance of approximately 8 cm can be achieved. As can readily be appreciated, the specific distance over which wireless power can be transmitted can vary as appropriate to the requirements of specific applications.

Although various wirelessly powered spectroscopy sensor system implementations are described above with reference to FIG. 1, any of a variety of spectroscopy sensor system implementations may be utilized as appropriate to the requirements of specific applications in accordance with various embodiments of the invention. Receiver antenna and rectifier are disclosed further below.

### Receiver Antenna and Rectifier

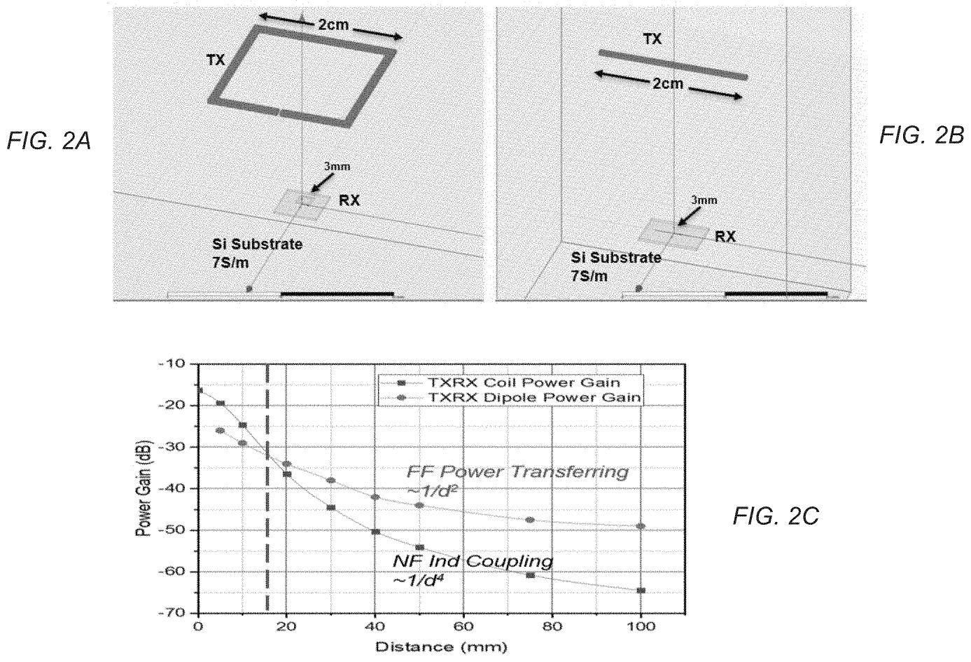

In determining the choice of the TX/RX antenna, a path loss performance of the TX/RX antennae can be simulated using an electro-magnetic (EM) simulator HFSS (Ansys, Canonsburg, Pa.). In FIG. 2A, structure for near-field inductive coupling coils are shown. FIG. 2B illustrates structure for far-field radiating dipole antennae in accordance with an embodiment of the invention. A comparison of a path loss performance of the inductive coupling coils to that of radiating dipole antennae is shown in FIG. 2C. As shown in FIG. 2C, for a distance larger than approximately 18 mm, the far field radiation with TX/RX dipole antennas can achieve higher power transfer efficiency with less path loss compared with near-field inductive coupling coils. Note that the specific distance where the dipole antennae outperform the inductive coupling coils can vary.

Although TX/RX antenna selection methods are described above with reference to FIGS. 2A-2C, any of a variety of TX/RX antenna selection methods may be utilized as appropriate to the requirements of specific applications in accordance with various embodiments of the invention. Various receiver antennas and rectifiers in accordance with certain embodiments of the invention are disclosed further below.

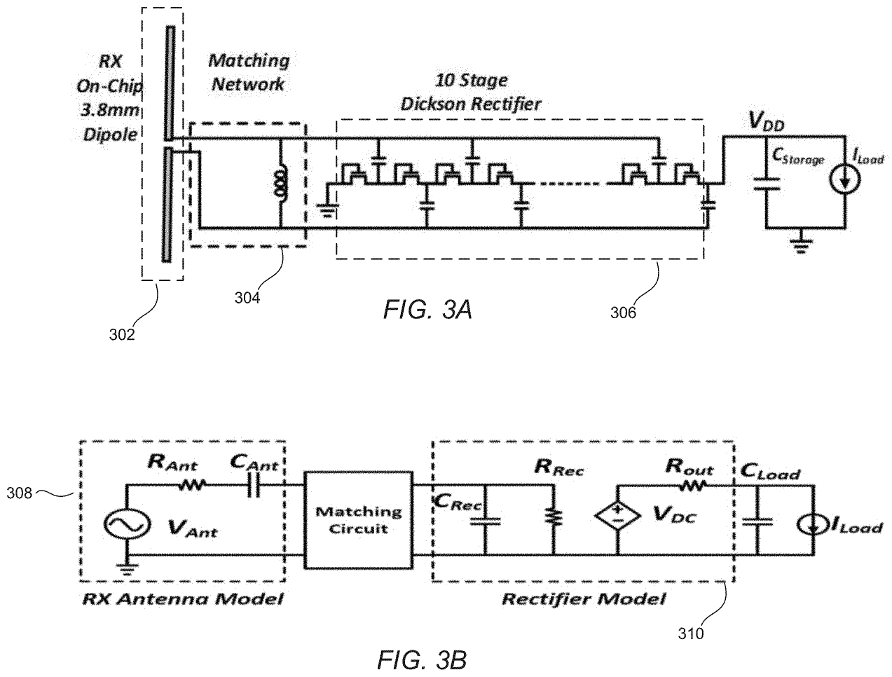

In several embodiments, the spectroscopy sensor can include an RX on-chip dipole antenna, a matching network and an RF to DC rectifier. A circuit schematic of an RX on-chip dipole antenna and a 10-stage Dickson rectifier in accordance with an embodiment of the invention is illustrated in FIG. 3A. As shown in FIG. 3A, an RX on-chip dipole antenna 302 is connected to a matching network 304, which is connected to a 10-stage Dickson rectifier 306. Note that the specific number of stages in the rectifier can vary. FIG. 3B illustrates electrical models for the on-chip RX antenna and for the rectifier in accordance with an embodiment of the invention. As shown in FIG. 3B, the electrical model for the on-chip RX antenna is shown as 308 and the electrical model for the rectifier is shown as 310.

Although FIGS. 3A and 3B illustrate a particular circuit schematic for an RX on-chip dipole antenna and 10-stage rectifier, any of a variety of circuit architectures may be utilized as appropriate to the requirements of specific applications in accordance with various embodiments of the invention. Antenna efficiency and simulations are discussed further below.

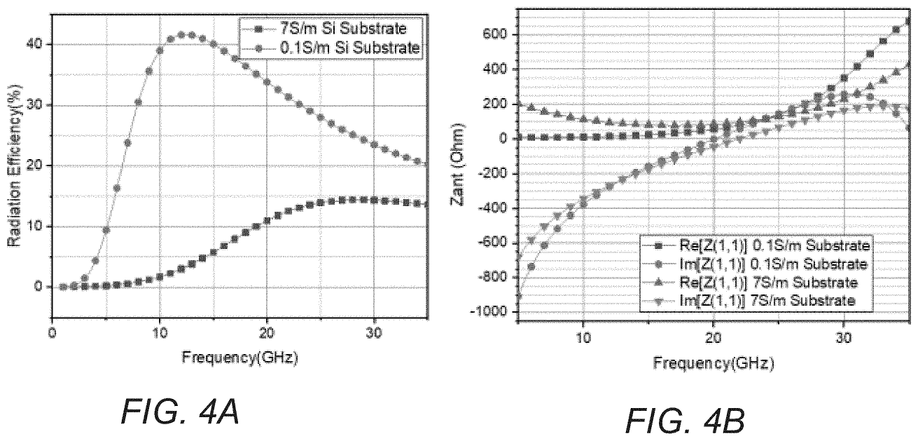

HFSS simulations can be utilized to analyze the antenna radiation efficiency and impedance. FIGS. 4A and 4B illustrate antenna radiation efficiency and impedance, respectively, simulated with HFSS. In a number of embodiments, due to the use of a low loss substrate in a SOI process, the antenna radiation efficiency at 9 GHz may be improved to 36% (SOI process) from 2% (Bulk process). Note that the specific numbers for frequency and the improvement in antenna efficiency can vary. In many embodiments, the electrical conductivity of the substrate used in a GF180 nm SOI process can be 0.1 S/m compared to approximately 7 S/m in a bulk CMOS process. Note that the specific number for electrical conductivity can vary as appropriate to the requirements of specific applications in accordance with various embodiments of the invention.

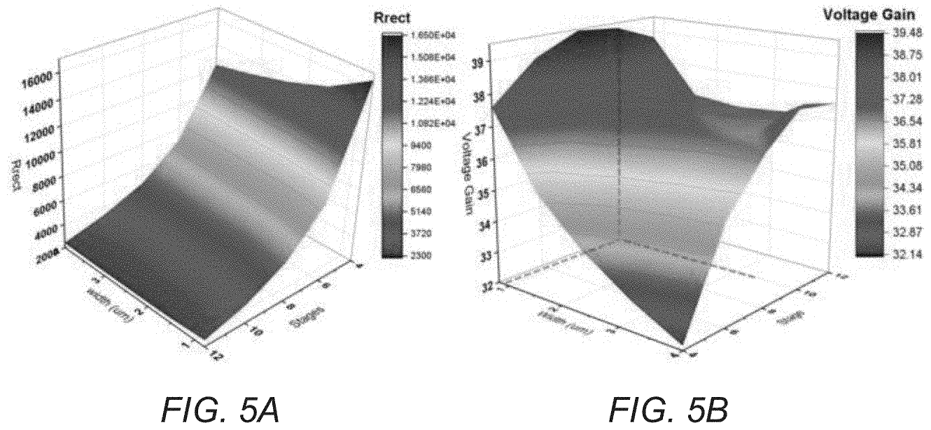

In several embodiments, the rectifier can be co-designed with an RX antenna to achieve a targeted DC output voltage with limited RX received power. Because of the duty-cycle operation, the power receiving front-end may be designed and implemented for the storage capacitor as a load in the charging phase, where the leakage current can be negligible. The number of stages and size of the diode connected NMOS in rectifier may be optimized based on the trade-off between the voltage swing and voltage multiplication factor (a diode connected NMOS is a NMOS transistor configured to act as a diode). The voltage swing at the rectifier input can be amplified by the matching circuit's passive gain, which may be related to the resistance ratio of the rectifier input and antenna resistance. Use of a larger number of rectifiers may increase the output voltage multiplication factor but can reduce the rectifier input resistance, as well as the passive gain. The rectifier resistance and voltage gain can be simulated as illustrated in FIGS. 5A and 5B, respectively, in accordance with an embodiment of the invention with a typical received power of −9 dBm captured by the on-chip antenna. With diode-connected NMOS width of 0.8 μm and using 10 stages, a maximum sensitivity of the power receiving front-end can be achieved. Note that the specific value for NMOS width and number of stages can vary. The rectifier sensitivity can be −16 dBm to achieve 1V DC voltage at the rectifier output. The specific numbers for sensitivity and voltage can vary. In certain embodiments, the RF to DC power conversion efficiency is 7% at this input power level. An on-chip inductor can be used to conjugate match the dipole antenna and rectifier. In a number of embodiments, a 3.4 nH on-chip inductor can be used to conjugate match the dipole antenna and rectifier at around 9 GHz. A capacitor can be integrated on the chip to store harvested energy. In several embodiments an MIM capacitor with a capacitance value of 2 nF may be integrated on the chip to store the harvested energy. Note that the specific numbers for inductor value, capacitor value and frequency can vary. Power management units that can be utilized in spectroscopy sensors and other circuits implemented in accordance with various embodiments of the invention are discussed further below.

### Power Management Units

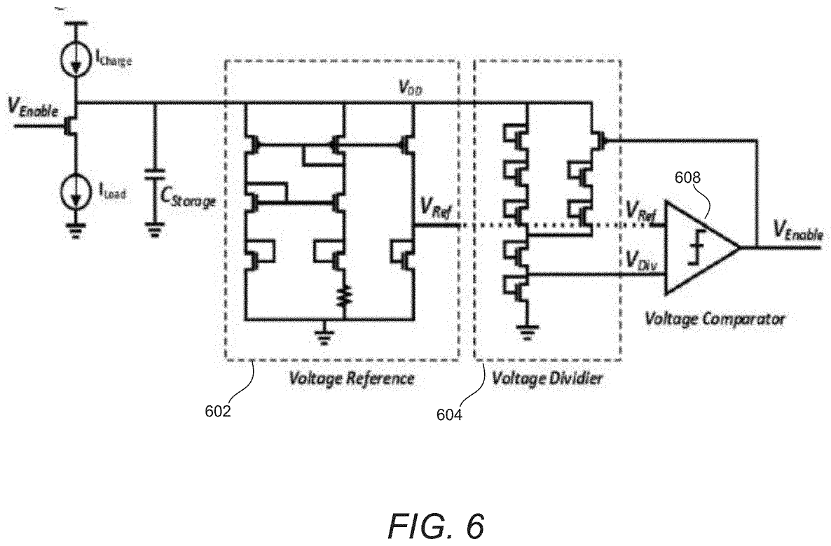

In several embodiments, the spectroscopy sensor can include a power management unit (PMU) circuit. A PMU circuit in accordance with an embodiment of the invention is illustrated in FIG. 6. In many embodiments, to further increase the wireless power sensitivity, the active circuits with high power consumption can be put in a sleep mode for most of the time in one period. In various embodiments, the voltage reference 602, voltage divider 604, and comparator 608 can form a Schmitt trigger for the active circuit. This may generate a logic 0 (e.g., disable signal) that may switch off both the oscillator and the low dropout regulator, when the storage capacitor is charged by the rectifier. In a number of embodiments, to switch on the oscillator and the low dropout regulator, the Schmitt trigger generates a logic 1 (e.g., enable signal). The leakage current of the PMU in sleep mode can be 200 nA, which may be negligible to the charging current received from the rectifier. In various embodiments, the LDO may generate a stable 1V supply voltage for the oscillator. Note that the specific values for the leakage current and the LDO voltage can vary. Although various PMU circuits are described above with reference to FIG. 6, any of a variety of power management unit circuit architectures may be utilized as appropriate to the requirements of specific applications in accordance with embodiments of the invention. Super-harmonic injection-locked oscillators in accordance with various embodiments of the invention are discussed further below.

### Super-Harmonic Injection-locked Oscillators

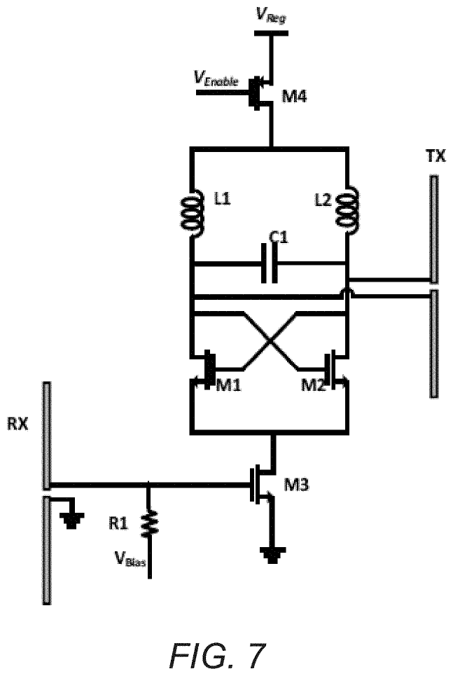

In several embodiments, the spectroscopy sensor can include a super-harmonic injection locked oscillator. A circuit schematic of a super-harmonic injection locked oscillator in accordance with an embodiment of the invention is illustrated in FIG. 7. In particular, FIG. 7 shows that the locking signal can be captured by another on-chip antenna and can be fed to the gate of the oscillator's current source. This signal, which can be used as an injection locking current for the oscillator, may lock the oscillation frequency to half of the injection frequency. Although use of an inductor having a large quality factor may improve phase noise and may require less power consumption of the oscillator, it may cause a smaller locking range. Considering this tradeoff, use of an inductor having a moderate quality factor of L2 can be chosen here to achieve a large locking range. In simulation, 8 dBm of received power at an RX dipole antenna may be needed to achieve a locking range from 4 to 5 GHz. Note that the specific values for received power and frequency range can vary. The current consumption of the oscillator may be 4 mA at a 1 V supply voltage when the oscillator's free-running frequency is 4.62 GHz. Note that the specific current consumption of the oscillator at a voltage and frequency can vary. Although specific super-harmonic injection locked oscillator circuits are described above with reference to FIG. 7, any of a variety of super-harmonic injection locked oscillator circuits can be utilized as appropriate to the requirements of specific applications in accordance with various embodiments of the invention. Measurement results are discussed further below.

### Measurements Results of the Wirelessly-Powered Sensor Chip

Microchip sensors implemented in accordance with various embodiments of the invention can be tested using a Keysight E8259D signal source to drive a power amplifier (PA) to transmit a 35 dBm EIRP signal through a horn antenna. The microchip sensor can receive the signal and radiate back a locked signal at the half frequency. The radiated signal can be captured by a custom PCB-based antenna. The spectrum of this signal can then be measured by a Keysight PXA N9030A spectrum analyzer.

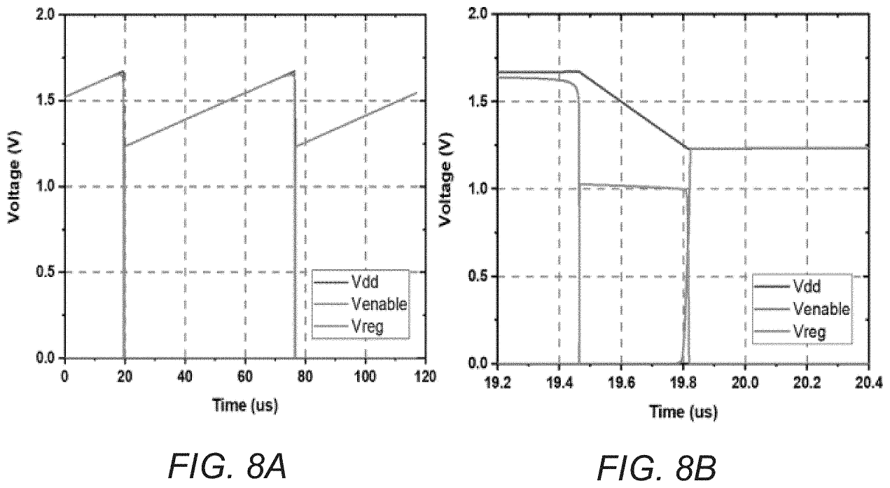

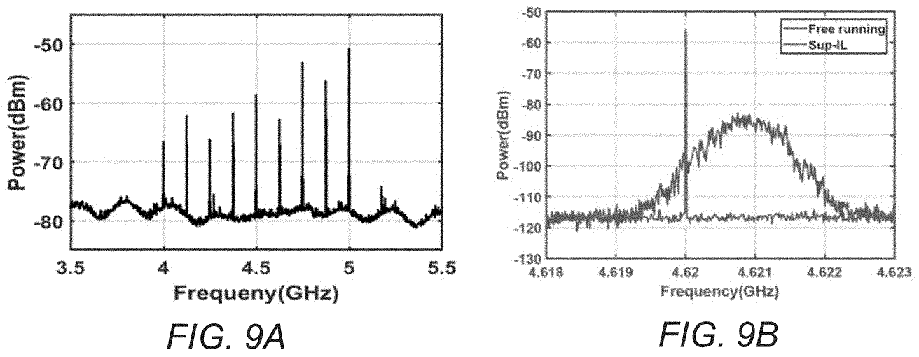

During testing, the maximum operating distance from the external TX to the chip was approximately 8 cm. FIG. 8A illustrates a transient result of the voltage on the storage capacitor (VDD), the regulated voltage at LDO output (V_{Reg}), and the enable signal (V_{Enable}). FIG. 8B shows a zoomed in region of the active time of the transient result of the voltage of FIG. 8A. The VDD signal may be charged to a higher threshold of 1.7V and discharged to a lower threshold of 1.2V. Note that the specific values for the higher and lower thresholds voltages can vary. FIG. 9A illustrates the spectrum of a locked oscillator from 4 GHz to 5 GHz, which corresponds to a large locking range of 22%. Note that the specific frequency value can vary. FIG. 9B shows a comparison of measured spectrum of an injected-locked signal with a free-running signal.

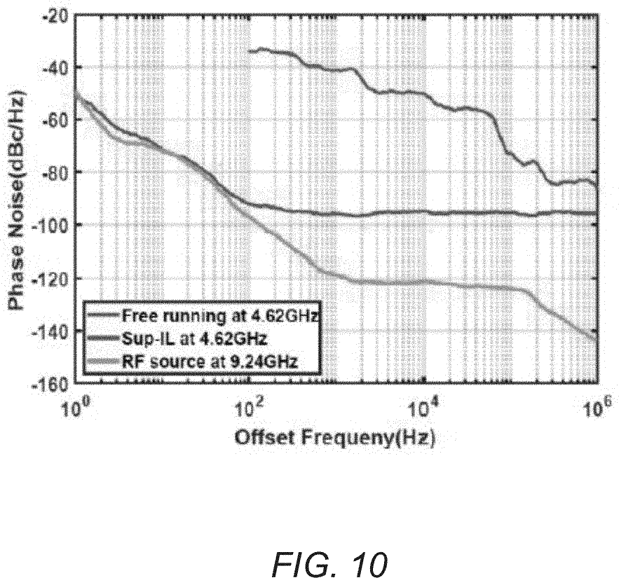

FIG. 10 illustrates the phase noise plotted in both modes. The phase noise may follow that of the RF source at low offset and may achieve a −93 dBc/Hz at 100 Hz offset in the locked mode. Note that the specific value of phase noise may vary. Compared to the phase noise in free-running mode, use of super-harmonic injection locking can improve phase noise by 60 dB. In certain embodiments, because of the small received power of around −60 dBm at the external RX antenna, the phase noise may become flat beyond the 100 Hz offset due to a thermal noise floor.

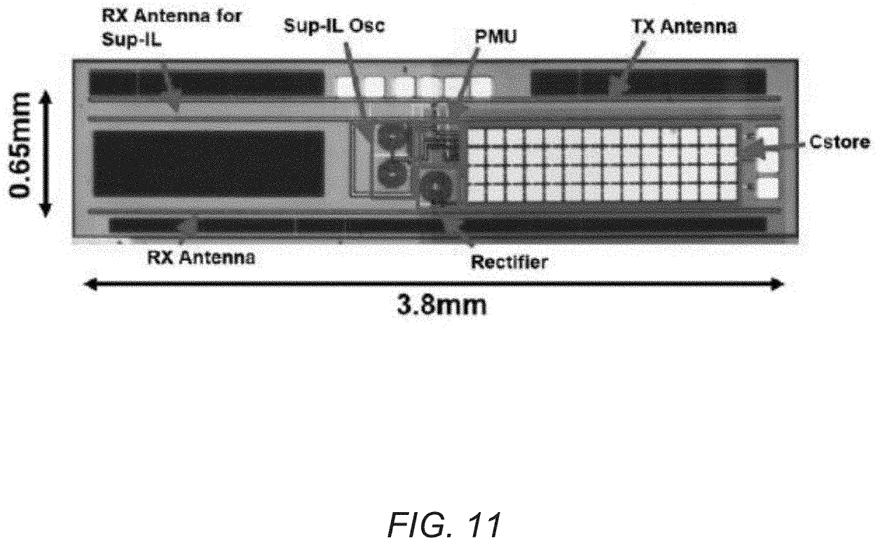

In several embodiments, the chip may be fabricated in a 180 nm CMOS SOI process and can occupy an area of 3.8×0.65 mm², including the on-chip antennas and the storage capacitor. Note that the specific area utilized to implement the circuit can vary in based upon the requirements of specific applications in accordance with various embodiments of the invention. A chip micrograph in accordance with an embodiment of the invention is illustrated in FIG. 11. Although FIG. 11 illustrates a particular chip architecture micrograph, any of a variety of chip architectures may be utilized as appropriate to the requirements of specific applications in accordance with embodiments of the invention.

### Spectroscopy Measurement

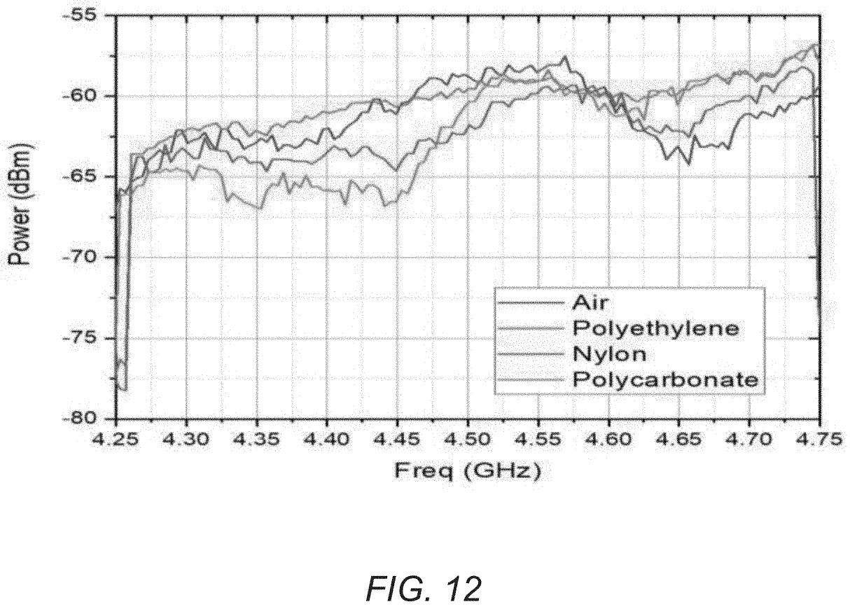

In various embodiments, the wide locking range of the spectroscopy sensors can be utilized to facilitate a transmission spectroscopy application, where a wirelessly-powered injection-locked oscillator can be used to measure the absorption spectrum of different materials including (but not limited to) water, oil, polyethylene, nylon and polycarbonate. Configured in this way, the TX antenna can transmit 0.5 W power in a frequency range of 8.5 GHz to 9.5 GHz, when placed 4 cm away from the chip. Note that the specific transmit power, frequency range and/or distance can vary. When the TX signal has a frequency range of 8.5 GHz to 9.5 GHz, the spectroscopy sensor chip can produce a locked signal with frequency ranging from 4.25 GHz to 4.75 GHz. The MUT can be placed between the microchip and a PCB-based RX antenna. The MUT may be at approximately 2 cm away from the microchip to be in far-field region of the microchip and to avoid changing on-chip antenna's radiation behavior. Note that the specific distance of the MUT from the spectroscopy sensor can vary. FIG. 12 illustrates the spectrum envelope received by the RX antenna with different MUTs in accordance with an embodiment of the invention. The measurement results show that water induces a larger absorption compared to oil. The polymer-based materials, polyethylene and polycarbonate may boost the signal transmission around 4.65 GHz, while increasing the absorption from 4.25 GHz to 4.4 GHz.

Many embodiments provide a fully integrated wirelessly powered spectroscopy sensor microchip, which includes an energy-harvesting front-end, a power management unit, a super-harmonic injection-locked oscillator, and on-chip antennas. In certain embodiments, the chip may achieve a maximum operating distance of 8 cm, a locking range of 22%, and a phase noise of −93 dBc/Hz at 100 Hz offset. Note that the specific value for operating distance, phase noise and frequency can vary. Based on the large locking range of the wirelessly-powered oscillator, broadband transmission spectroscopy can be used to differentiate materials based on their absorption spectrum.

Although specific implementations for a wirelessly powered spectroscopy sensor microchip are discussed above, any of a variety of implementations utilizing the above discussed techniques can be utilized to implement wirelessly powered spectroscopy sensors in accordance with various embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A wirelessly powered spectroscopy sensor, comprising:
a first antenna configured to receive an incoming signal;
an energy-harvesting circuit configured to produce DC energy;
a power management unit;
an on-chip signal source configured to use the incoming signal as a locking signal; and
a second antenna configured to transmit back a signal locked to the frequency of the incoming signal.

2. The wirelessly powered spectroscopy sensor of claim 1, wherein the first antenna is an on-chip antenna.

3. The wirelessly powered spectroscopy sensor of claim 1, wherein the first antenna is an off-chip antenna.

4. The wirelessly powered spectroscopy sensor of claim 1, wherein the second antenna is an on-chip antenna.

5. The wirelessly powered spectroscopy sensor of claim 1, wherein the second antenna is an off-chip antenna.

6. The wirelessly powered spectroscopy sensor of claim 1, wherein the on-chip signal source is an on-chip oscillator.

7. The wirelessly powered spectroscopy sensor of claim 6, wherein the on-chip oscillator is a super-harmonic injection-locked oscillator.

8. The wirelessly powered spectroscopy sensor of claim 1, wherein the wirelessly powered spectroscopy sensor is configured to utilize frequency division duplexing.

9. The wirelessly powered spectroscopy sensor of claim 1, wherein the wirelessly powered spectroscopy sensor is fabricated using a silicon process.

10. The wirelessly powered spectroscopy sensor of claim 1, wherein the wirelessly powered spectroscopy sensor is configured to use a duty cycle operation mode to provide a large instantaneous power in order to reduce an average power consumption of the sensor.

11. The wirelessly powered spectroscopy sensor of claim 1, further comprising a third antenna.

12. The sensor chip of claim 11, wherein the third antenna is an on-chip antenna.

13. The wirelessly powered spectroscopy sensor of claim 1, wherein the wirelessly powered spectroscopy sensor is configured to radiate a signal through a material under test (MUT), wherein the signal is used to perform transmission spectroscopy of the MUT.

14. A sensor chip, comprising:
a first antenna configured to receive an incoming signal;
an energy-harvesting circuit configured to produce DC energy;
a power management unit;
an on-chip signal source configured to use the incoming signal as a locking signal;
a second antenna configured to transmit back a signal locked to the frequency of the incoming signal; and
a third antenna configured to receive the locked signal.

15. The sensor chip of claim 14, wherein the first antenna is an on-chip antenna.

16. The sensor chip of claim 14, wherein the first antenna is an off-chip antenna.

17. The sensor chip of claim 14, wherein the second antenna is an on-chip antenna.

18. The sensor chip of claim 14, wherein the second antenna is an off-chip antenna.

19. The sensor chip of claim 14, wherein the on-chip signal source is an on-chip oscillator.

20. The sensor chip of claim 19, wherein the on-chip oscillator is a super-harmonic injection-locked oscillator.
